(19) United States
(12) Patent Application Publication
(10) Pub. No.: US 2010/0170722 A1
(43) Pub. Date: Jul. 8, 2010

(54) LOAD DETECTING DEVICE, SEAT, AND LOAD SENSOR

(75) Inventor: Ryoichi MAEDA, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/642,671

(22) Filed: Dec. 18, 2009

(30) Foreign Application Priority Data
Jan. 8, 2009 (JP) 2009-002428

(51) Int. Cl. G01G 19/08

(52) U.S. Cl. 177/136

(57) ABSTRACT

A load detecting device includes: a load sensor which outputs a signal in response to a load; and a plurality of tensile members which support the load sensor in a state where the load sensor is tensioned in multiple directions and stretch the load sensor in the multiple directions by receiving the load, wherein the load sensor outputs a signal in response to the load received by the plurality of tensile members on the basis of tensile forces of the plurality of tensile members.

### CROSS REFERENCE TO RELATED APPLICATIONS

The present invention contains subject matter related to and claims priority to Japanese Patent Application No. 2009-002428 filed in the Japanese Patent Office on Jan. 8, 2009, the entire contents of which are incorporated herein by reference.

### BACKGROUND

1. Technical Field

The present disclosure relates to a load detecting device for detecting the weight of an occupant in a vehicle, a seat, and a load sensor.

2. Related Art

In general, an airbag system is provided inside a vehicle to protect an occupant of the vehicle. The airbag system supplies inert gas inside a folded bag in an accidental collision and rapidly deploys the bag to protect the occupant from the impact of the accident. In this airbag system, the amount of the inert gas supplied is adjusted according to the weight of the occupant so that in the case of a light-weight occupant the amount of the inert gas to be supplied is decreased to reduce the impact of the deployed bag and in the case of a heavy-weight occupant the amount of the inert gas to be supplied is increased to give sufficient supporting force from the bag.

In the past, as a load detecting device for detecting the weight of an occupant in such an airbag system, there is known a technique for detecting the weight of an occupant using a plurality of load sensors (for example, refer to Japanese Unexamined Patent Application Publication No. 2005-233821). The load detecting device includes four load sensors which are positioned at four corresponding corners on the lower side of a seating surface, and a support mechanism which supports the seat from below via the four load sensors to be movable in a forward and rearward direction, so as to calculate the weight of the occupant on the basis of the detection results of the four load sensors.

### SUMMARY

However, in the load detecting device disclosed in Japanese Unexamined Patent Application Publication No. 2005-233821, since the weight of the occupant is detected by the four load sensors, the number of components is increased. In addition, since the seat is supported from below by the four load sensors, each sensor requires a mechanical strength to bear the impact during a crash, resulting in an increase in manufacturing costs. In addition, since the seat is supported from below by the support mechanism and the four load sensors, the position of the seat has to be raised, resulting in poor design characteristics.

It is desirable to provide a load detecting device, a seat, and a load sensor capable of detecting a load, with a reduction in manufacturing costs and without degrading the design characteristics.

According to an aspect of the invention, there is provided a load detecting device including: a load sensor which outputs a signal in response to a load; and a plurality of tensile members which support the load sensor in a state where the load sensor is tensioned in multiple directions and stretch the load sensor in the multiple directions by receiving the load, wherein the load sensor outputs a signal in response to the load received by the plurality of tensile members on the basis of tensile forces of the plurality of tensile members.

In this configuration, since the load sensor is stretched in multiple directions under the load received by the plurality of tensile members and outputs the signal in response to the load on the basis of tensile forces of the plurality of tensile members, thereby detecting a signal in response to the load using the single load sensor. In addition, for example, a configuration in which a load is detected by externally supporting an attachment object such as a seat is not used, and the load sensor can be incorporated into the attachment object, so that design characteristics of the attachment object are not degraded. Therefore, the load can be detected without degrading the design characteristics and with a reduction in manufacturing costs.

In the load detecting device according to the aspect of the invention, the load sensor includes: a plurality of attachment portions to which the plurality of tensile members are attached, respectively; and a plurality of strain-resistant elements which are provided to correspond to the plurality of attachment portions, and of which resistances are changed by the stretching tensile members attached to the respective attachment portions, and wherein the load sensor outputs a signal in response to the load received by the plurality of tensile members according to a change in the resistance of the strain-resistant element.

In this configuration, since the resistance of the strain-resistant element is changed as the plurality of attachment portions are stretched by the respective tensile members, the signal in response to the load received by the plurality of tensile members can be output, thereby implementing the load sensor in the simple configuration.

In the load detecting device according to the aspect of the invention, the tensile member is a wire made of a low-modulus material.

In this configuration, it is possible to improve detection precision of a tensile detection portion by suppressing elongation of the plurality of tensile members.

In the load detecting device according to the aspect of the invention, the number of tensile members is at least three, and a guide member which connects the neighboring tensile members is provided.

In this configuration, since the neighboring tensile members are connected by the guide member, the load applied on each tensile member is distributed by the guide member, thereby preventing damage to each tensile member due to the concentrated load.

In the load detecting device according to the aspect of the invention, the number of tensile members is four, and the tensile members support the load sensor in a state where the load sensor is tensioned in four directions.

In this configuration, the load sensor may be stably supported by the four tensile members.

According to another aspect of the invention, there is provided a seat including: the load detecting device; and a seat pad, wherein the plurality of tensile members receives the seating load of the seat pad.

In this configuration, the seating load of a user on a seat can be detected without degrading the design characteristics and with a reduction in manufacturing costs. Therefore, it can be applied to an occupant protecting device such as an airbag system.

According to further another aspect of the invention, there is provided a seat including: the load detecting device; and a seat pad, wherein the plurality of tensile members receive a seating load of the seat pad, and a recess portion is provided in the seat pad to prevent the contact with the load sensor.

In this configuration, the seating load which is received via the seat pad can be concentrated on the plurality of tensile members, and contact between the seat pad and the load sensor is prevented, thereby preventing damage to the load sensor.

According to still another aspect of the invention, there is provided a load sensor which is supported by a plurality of tensile members that are stretched in multiple directions in a state where the load sensor is tensioned under a load, and outputs a signal in response to the load received by the plurality of tensile members on the basis of tensile forces of the plurality of tensile members.

In this configuration, the plurality of tensile members are stretched in multiple directions under the load, and the signal is output in response to the load on the basis of the tensile forces of the tensile members, thereby detecting the signal in response to the load using the single load sensor.

Accordingly, a load can be detected without degrading the design characteristics and with a reduction in manufacturing costs.

### BRIEF DESCRIPTION OF THE DRAWINGS

FIG. 1 is a schematic sectional view illustrating a seat having a load detecting device according to an embodiment of the invention.

FIG. 2 is a schematic top view illustrating the load detecting device according to the embodiment of the invention.

FIG. 3 is a schematic top view illustrating a load sensor of the load detecting device according to the embodiment of the invention.

FIG. 4 is a circuit diagram illustrating an example of a load detecting circuit of the load detecting device according to the embodiment of the invention.

FIGS. 5A and 5B are explanatory views of a load detecting operation using a seat applying the load detecting device according to the embodiment of the invention.

FIG. 6 is a view illustrating a load detecting device according a modified example of the invention.

FIG. 7 is a view illustrating the load detecting device according to another usage example of the invention.

### DESCRIPTION OF EXEMPLARY EMBODIMENTS

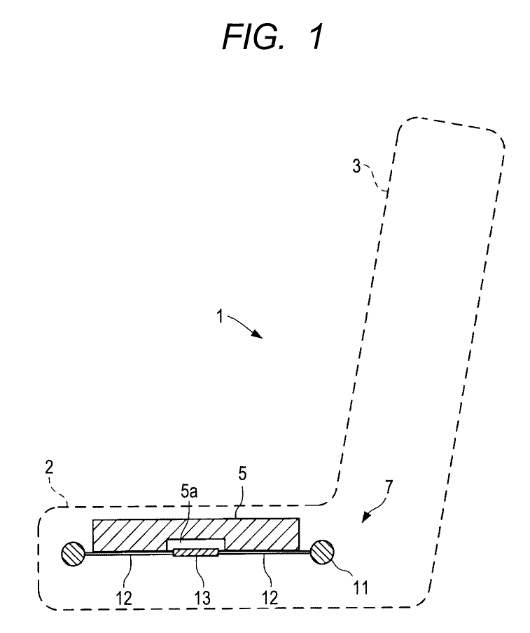

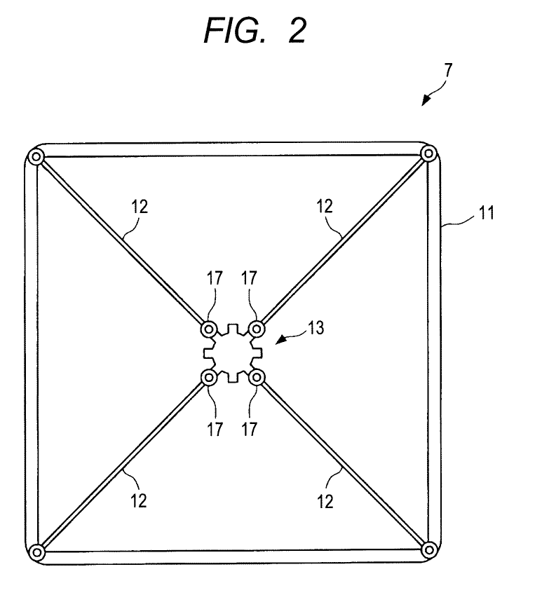

Hereinafter, exemplary embodiments of the invention will be described in detail with reference to the accompanying drawings. FIG. 1 is a schematic sectional view illustrating a seat having a load detecting device according to an embodiment of the invention. FIG. 2 is a schematic top view of the load detecting device according to the embodiment of the invention. In addition, dashed lines in FIG. 1 show the contour of the seat for a vehicle. In the following description, a seat for a vehicle, which has a load detecting sensor, will be exemplified. However, those may be applied to, for example, a bed or a toilet seat as long as they have a load detecting sensor attached, and they may be applied to detect loads of animals or objects as well as humans.

As illustrated in FIG. 1, a seat 1 is a seat for a vehicle which includes a seat portion 2 and a backrest portion 3. Inside a seat cover (not shown) of the seat portion 2, a seat pad 5 on which an occupant seats and a load detecting device 7 which detects a seating load of the occupant via the seat pad 5 are provided. The seat pad 5 is formed of urethane foam in a plate shape and is mounted in the load detecting device 7. A concave portion 5a is formed at the center of a lower portion of the seat pad 5. Due to the concave portion 5a, a load sensor 13 of the load detecting device 7 which will be described later is prevented from contacting the lower surface of the seat pad 5.

The load detecting device 7 for detecting a seating load using a tensile force includes a support frame 11 having a rectangular frame shape which is fixed to a supporting surface (not shown) of the seat 1 to be parallel with the seating surface. The load sensor 13 is supported by the support frame 11 via a plurality of (in this embodiment, four) wires 12, and the load sensor 13 is positioned at the center in the support frame 11.

As illustrated in FIG. 2, the plurality of wires 12 is formed of a low-modulus material, one end of each wire is fixed to four corresponding corners of the support frame 11, and the other ends are attached to corresponding attachment portions 17 provided in four directions of the load sensor 13. Here, a length of each wire 12 is adjusted to be such a length that the wire 12 does not loosen while being attached to the support frame 11 and the load sensor 13, that is, the shortest length from an attachment position of the attachment portion 17 of the load sensor 13 to an attachment position of the corresponding corner of the support frame 11. Therefore, in the embodiment, since the load sensor 13 is positioned at the center in the support frame 11, the wires 12 are adjusted to have the same length.

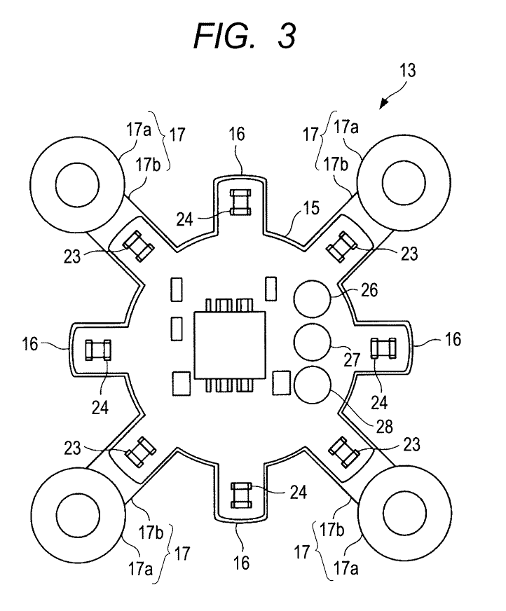

As described above, since the load sensor 13 is supported by the plurality of wires 12 in the state where the load sensor 13 is tensioned in four directions, when the wires 12 receive a seating load via the seat pad 5, the load sensor 13 is stretched in four directions by the wires 12. The load sensor 13 outputs a signal in response to the seating load on the basis of a strain which occurs in each attachment portion 17 due to the stretching wires 12. Here, the configuration of the load sensor according to the embodiment of the invention will be described in detail with reference to FIG. 3. FIG. 3 is a schematic top view of the load sensor according to the embodiment of the invention.

As illustrated in FIG. 3, the load sensor 13 includes a disc-shaped substrate 15, the four attachment portions 17 which protrude toward the four corresponding corners of the support frame 11 from the substrate 15, and four convex portions 16 which are positioned between the neighboring attachment portions 17 to protrude outward in a radial direction from the substrate 15. Each attachment portion 17 includes a wire fixing portion 17a to which the wire 12 is fixed, and an arm portion 17b which connects the wire fixing portion 17a and the substrate 15.

The arm portion 17b functions as a strain member which is strained by a stress, and has a strain-resistant element 23 attached on the surface. The strain-resistant element 23 is configured as a strain gauge or the like and is attached so that the length of the gauge is aligned with the stretching direction due to the wire 12, that is, the elongating direction of the arm portion 17b. In addition, since the wire fixing portion 17a is configured to be thicker than the arm portion 17b, the only arm portion 17b is strained. Therefore, the arm portion 17b is stretched and is strained by the wire 12 via the wire fixing portion 17a, and the resistance of the strain-resistant element 23 is changed.

A reference resistant element 24 is attached on the surface of the convex portion 16. Here, since the convex portion 16 is positioned between the neighboring attachment portions 17 to protrude from the substrate 15, as described above, thereby suppressing stress that may occur due to the stretch of the wire 12. Accordingly, in this configuration, a constant resistance can be maintained without an external force added to the reference resistant element 24.

At the center of the surface of the substrate 15, electronic components which constitute a load detecting circuit for detecting a seating load in cooperation with the strain-resistant element 23 and the reference resistant element 24 are provided, and on the right in the figure from the center of surface of the substrate 15, an input terminal 26, an output terminal 27, and a ground terminal 28 are provided. A power source (not shown) is connected to the input terminal 26 via a power line, and an input voltage is applied to the load detecting circuit from the power source. An Electronic Control Unit (ECU) (not shown) is connected to the output terminal 27 via a signal line, and a signal is output to the ECU in response to the detected seating load. The signal output from the output terminal 27 in response to the seating load is used for an occupant protecting device such as an airbag system. The ground terminal 28 is connected to a ground via a ground line.

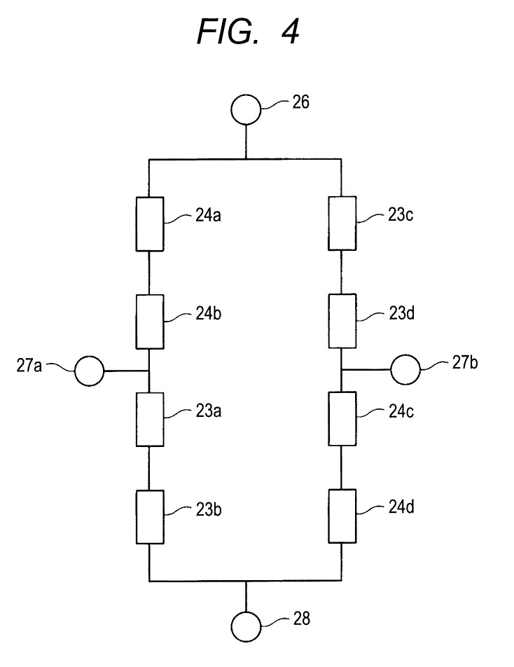

An example of the load detecting circuit according to the embodiment of the invention will be described with reference to FIG. 4. FIG. 4 is a circuit diagram illustrating the example of the load detecting circuit according to the embodiment of the invention.

As illustrated in FIG. 4, the load detecting circuit is configured as a bridge circuit by strain-resistant elements 23a to 23d, reference resistant elements 24a to 24d, the input terminal 26, the ground terminal 28, and first and second output terminal 27a and 27b. Specifically, a series circuit in which the reference resistant elements 24a and 24b and the strain-resistant elements 23a and 23b are connected in series in this order between the input terminal 26 and the ground terminal 28, and a series circuit in which the strain-resistant element 23c and 23d and the reference resistant element 24c and 24d are connected in series in this order are connected in parallel. In addition, the first output terminal 27a is drawn from a junction between the reference resistant element 24b and the strain-resistant element 23a, and the second output terminal 27b is drawn from a junction between the strain-resistance element 23d and the reference resistant element 24c.

In the load detecting circuit, as a power source voltage is applied between the input terminal 26 and the ground terminal 28, an output voltage is generated between the first and second output terminals 27a and 27b, and a potential difference between the first and second output terminals 27a and 27b is output from the output terminal 27 (see FIG. 3). In this case, the resistances of the reference resistant elements 24a to 24d are set so that a potential between the input terminal 26 and the first output terminal 27a and a potential between the input terminal 26 and the second output terminal 27b are equal to each other when a tensile stress does not occur in the arm portion 17b of the load sensor 13.

In the load detecting circuit having the above-mentioned configuration, when the plurality of wires 12 receives a seating load, a tensile stress occurs in the arm portion 17b of the load sensor 13 due to the wires 12, so that the resistance of the strain-resistant element 23 is changed. Here, since a stress does not occur in the convex portion 16 of the load sensor 13, the resistance of the reference resistant element 24 maintains to be constant, and the only resistance of the strain-resistant element 23 is changed. Therefore, it is possible to detect the seating load due to the change in the potential difference between the output voltages of the first and second output terminals 27a and 27b.

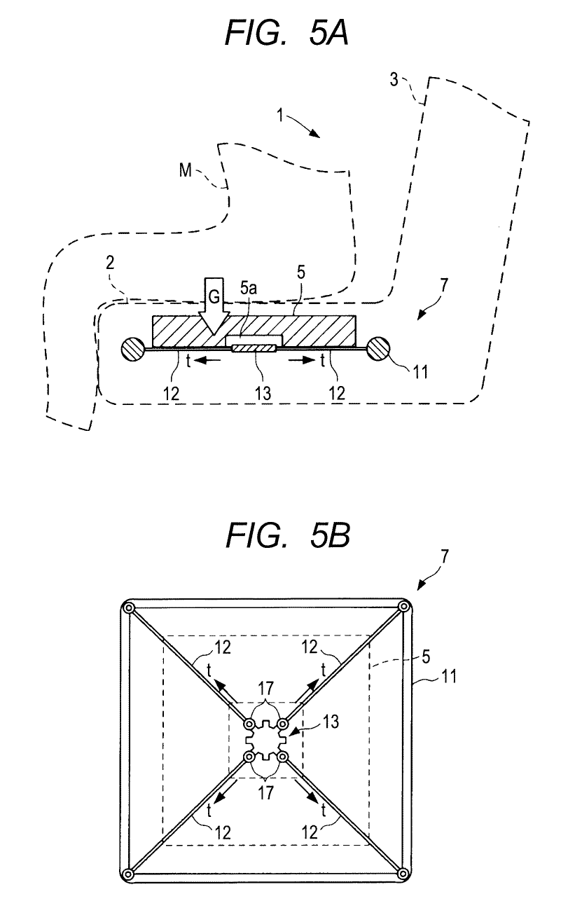

Hereinafter, a load detecting operation using a seat according to the embodiment of the invention will be described with reference FIGS. 5A and 5B. FIGS. 5A and 5B are explanatory views of the load detecting operation using a seat according to the embodiment of the invention.

As illustrated in FIG. 5A, when an occupant M seats on the seat pad 5, a seating load is applied to the plurality of wires 12 downwards in the vertical direction as shown by an arrow G When the seating load is applied to the plurality of wires 12, the load sensor 13 is stretched by the plurality of wires 12 in directions shown by arrows t. Here, as illustrated in FIG. 5B, the arm portions 17b of the load sensor 13 are stretched towards the four corresponding corners of the support frame 11 via the wire fixing portions 17a, and a tensile stress occurs in each arm portion 17b.

When a tensile stress occurs in each arm portion 17b, the gauge length of the strain-resistant element 23 is changed, and the resistance is changed. In the load detecting circuit, the potential difference between the output voltages of the first and second output terminals 27a and 27b is detected as a signal in response to the seating load, and the detection result is output to the ECU. Here, since the concave portion 5a is provided in the seat pad 5, the seating load which is applied via the seat pad 5 can be concentrated on the plurality of wires 12, and the contact between the seat pad 5 and the load sensor 13 is prevented, thereby preventing the damage to the load sensor 13.

As described above, in the load detecting device 7 according to the embodiment, since the load sensor 13 is stretched in multiple directions by the load received by the plurality of wires 12 and a signal is output in response to the load on the basis of the tensile force of the plurality of wires 12, it is possible to detect the signal in response to the load using the single load sensor 13. In addition, since the load detecting device 7 is provided inside the seat 1, the design characteristics of the seat 1 are not degraded. Therefore, it is possible to detect the load without degrading the design characteristics and with a reduction in manufacturing costs.

In this embodiment, the configuration in which the seating load is detected continuously from a correlation of the potential difference between the output voltages of the first and second output terminals 27a and 27b and the seating load is employed. However, a configuration in which the seating load is divided into a plurality of ranges to be detected step by step may be employed. Accordingly, the adjustment of a material, an extension state, or the like of the wire 12 can be easily performed. For example, the configuration is effective for operating the airbag system by determining whether the occupant M is an adult or a child.

In this embodiment, the load sensor 13 is disposed at the center of the support frame 11. However, the configuration is not limited thereto. As long as the length of each wire 12 is adjusted to be the shortest length from the attachment position of the attachment portion 17 of the load sensor 13 to the attachment position of the corresponding corner of the support frame 11, it is possible to support the load sensor 13 in the range of the support frame 11 so as not to loosen by the plurality of wires 12 even when the load sensor 13 is disposed at a position other than the center.

In the configuration of the embodiment, the bridge circuit including the strain-resistant element 23 is used for detecting a seating load, however, the configuration is not limited thereto as long as the seating load can be detected by the stretching of the wire 12.

In the configuration of the embodiment, the wire 12 is used to receive the load of the occupant M. However, the configuration is not limited thereto as long as the load sensor 13 is stretched by receiving the load of the occupant M. For example, a configuration using a strap-shaped member formed in a strap shape may be used.

In the configuration of the embodiment, the plurality of wires 12 is fixed to the four corresponding corners of the support frame 11. However, the configuration is not limited thereto. A configuration in which a plurality of wires 12 is provided to be attached and detected so as to fix the plurality of wires 12 to arbitrary points.

In the configuration of the embodiment, the four attachment portions 17 are provided in the load sensor 13. However, the configuration is not limited thereto as long as the load sensor 13 can be supported by the stretching wires 12. For example, two wires 12 may be attached to two attachment portions 17 to support the load sensor 13.

In the configuration of the embodiment, the single wire 12 is attached to the single attachment portion 17 of the load sensor 13 so as to stretch the load sensor 13 in four directions. However, the configuration is not limited thereto. For example, a plurality of the wires 12 may be attached to the single attachment portion 17 so as to stretch the sensor 13 in multiple directions. Accordingly, it is possible to decrease the load applied to each wire 12 and improve the durability.

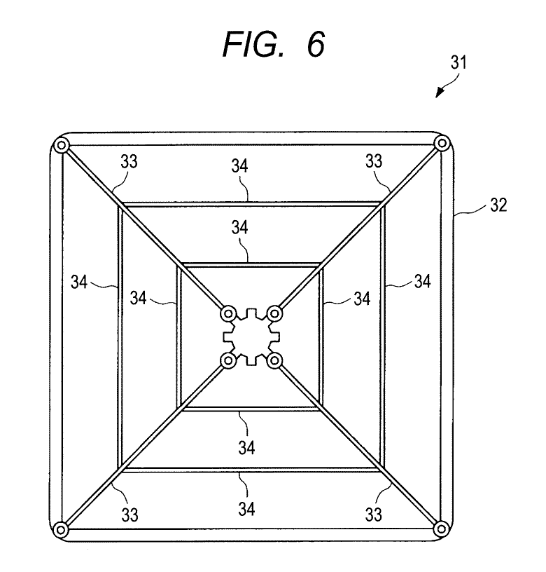

In the configuration of the embodiment, the load sensor 13 is individually stretched by each wire 12. However, as illustrated in FIG. 6, a guide wire 34 may be connected between neighboring wires 33. Accordingly, it is possible to distribute the load applied to the wires 33 and prevent the damage to each tensile member due to the concentrated load.

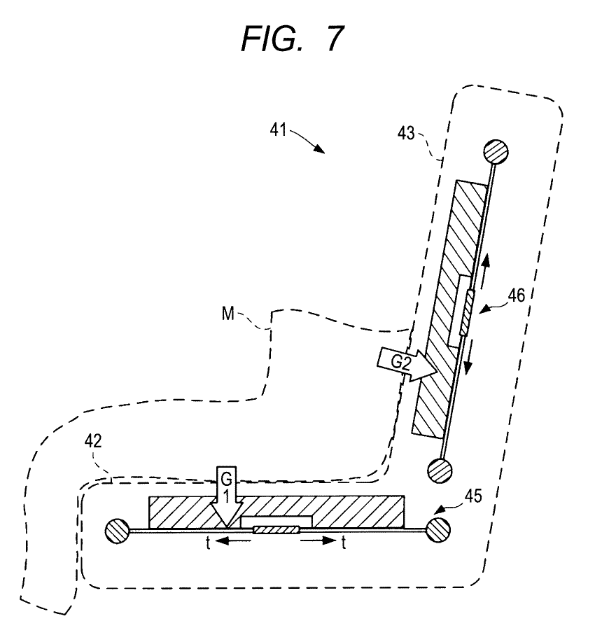

In the configuration of the embodiment, the load detecting device 7 is provided only in the seat portion 2. However, as illustrated in FIG. 7, a configuration in which a load detecting device 46 is provided in a backrest portion 43 may be employed. In this case, the seating load of the occupant M is detected on the basis of an output signal of the load detecting device 45 provided in the seat portion 42 and an output signal of the load detecting device 46 provided in the backrest portion 43. Since the seat portion 42 and the backrest portion 43 are provided with the load detecting devices 45 and 46, it is possible to detect the seating load of the occupant M even in the seat 41 having a backrest with good precision.

It should be understood by those skilled in the art that various modifications, combinations, sub-combinations and alterations may occur depending on design requirements and other factors insofar as they are within the scope of the appended claims of the equivalents thereof.

As described above, the embodiment of the invention has advantages in that a load can be detected without degrading the design characteristics with a reduction in the manufacturing cost, and it is particularly useful for the load detecting device for detecting the weight of the occupant in a vehicle, the seat, and load sensor.

What is claimed is:

1. A load detecting device comprising:
a load sensor which outputs a signal in response to a load; and
a plurality of tensile members which support the load sensor in a state where the load sensor is tensioned in multiple directions and stretch the load sensor in the multiple directions by receiving the load,
wherein the load sensor outputs a signal in response to the load received by the plurality of tensile members on the basis of tensile forces of the plurality of tensile members.

2. The load detecting device according to claim 1,
wherein the load sensor includes:
a plurality of attachment portions to which the plurality of tensile members are attached, respectively; and
a plurality of strain-resistant elements which are provided to correspond to the plurality of attachment portions, and of which resistances are changed by the stretching tensile members attached to the respective attachment portions, and
wherein the load sensor outputs a signal in response to the load received by the plurality of tensile members according to a change in the resistance of the strain-resistant element.

3. The load detecting device according to claim 1, wherein the tensile member is a wire made of a low-modulus material.

4. The load detecting device according to claim 1,
wherein the number of tensile members is at least three, and
a guide member which connects the neighboring tensile members is provided.

5. The load detecting device according to claim 1,
wherein the number of tensile members is four, and
the tensile members support the load sensor in a state where the load sensor is tensioned in four directions.

6. A seat comprising:
the load detecting device according to claim 1; and
a seat pad,
wherein the plurality of tensile members receive a seating load of the seat pad.

7. A seat comprising:
the load detecting device according to claim 1; and
a seat pad,
wherein the plurality of tensile members receive a seating load of the seat pad, and
a recess portion is provided in the seat pad to prevent the contact with the load sensor.

8. A load sensor which is supported by a plurality of tensile members that are stretched in multiple directions in a state where the load sensor is tensioned under a load, and outputs a signal in response to the load received by the plurality of tensile members on the basis of tensile forces of the plurality of tensile members.
